(19) United States
(12) Patent Application Publication
(10) Pub. No.: US 2007/0006325 A1
(43) Pub. Date: Jan. 4, 2007

(54) METHOD, SYSTEM AND COMPUTER PROGRAM FOR CONTROLLING ACCESS TO RESOURCES IN WEB APPLICATIONS

(76) Inventor: Gianluca Gargaro, Rome (IT)

Correspondence Address: IBM CORPORATION;INTELLECTUAL PROPERTY LAW, 11400 BURNET ROAD, AUSTIN, TX, 78758, US

(21) Appl. No.: 11/427,426

(22) Filed: Jun. 29, 2006

(30) Foreign Application Priority Data
Jun. 30, 2005 (EP) 05300542.7

(51) Int. Cl. H04L 9/32

(52) U.S. Cl. 726/27

(57) ABSTRACT

A method (300) for controlling access to resources of a data processing system is proposed. The method includes the steps under the control of a server entity (105) of: receiving (306) a request for accessing at least one selected resource from a client entity (110), the request being addressed to a software component (225, 230) running in a software container (255) adapted to interface the component with a software platform of the server entity, intercepting (309-312) the request by a filter (265) of the container, requesting (324) an authorization to access the at least one selected resource of the intercepted request to an authorization service, and returning (363) an error message to the client entity in response to a denial (330) of the authorization, or passing (348) the request to the component in response to a grant (339) of the authorization.

### FIELD OF THE INVENTION

The present invention relates to the data processing field. More specifically, the present invention relates to the control of the access to resources of a data processing system.

### BACKGROUND ART

Security is a key issue in modern data processing systems. Security concerns are particularly acute in systems with distributed architecture; these problems have been further exacerbated in the last years by the widespread diffusion of the Internet.

A specific security aspect is the control of the access to protected resources of the system by different users. In this context, it is of the utmost importance to avoid that unauthorized users might perform undesired operations on the protected resources. For this purpose, several security applications are available for defining security policies and for enforcing their application (such as the “Tivoli Access Manager or AM” by IBM Corporation).

The security applications known in the art are designed to serve native requests, which are submitted by a corresponding resource manager of the security application. Moreover, some security applications (such as the above-mentioned “Access Manager”) also expose a set of standard Application Program Interfaces (APIs); in this case, the use of the security application can be extended to different resource managers.

However, the integration of the existing security applications in specific environments is decidedly nontrivial. A typical example is a web application, for example, based on the Java 2 (Java is a trademark of registered trademark of Sun Microsystme, Inc in the United States and other countries) Enterprise Edition (J2EE) technology. In this case, the users (logged on client computers) request the execution of application programs running on a server computer; the operation is typically performed through an interface based on web pages.

A possible solution for integrating the web application with a pre-existing security application is of using a proxy computer; the proxy can then interface with the security application so as to enforce the desired security policy. Another possibility is of using a subset of servers where a plug-in for accessing the security application is already available.

However, both choices are quite intrusive. Particularly, their implementation requires that the web application should be accordingly updated. Moreover, the proposed solution cannot be applied to pre-existing web applications.

### SUMMARY OF THE INVENTION

The present invention proposes a solution, which is based on filtering techniques.

Particularly, an aspect of the present invention proposes a method for controlling access to resources of a data processing system. The method includes a series of steps, which are executed under the control of a server entity. The method starts by receiving a request for accessing one or more selected resources from a client entity; the request is addressed to a software component, which runs in a software container (adapted to interface the component with a software platform of the server entity). The request is intercepted by a filter of the container. The method continues by requesting an authorization to access the selected resources (of the intercepted request) to an authorization service. An error message is then returned to the client entity in response to a denial of the authorization; conversely, the request is passed to the component in response to a grant of the authorization.

In a preferred embodiment of the invention, a user of the client is authenticated in response to the interception of the request (before requesting the authorization).

As a further improvement, the authentication is performed by a dedicated component (such as a servlet).

Advantageously, the request is filtered according to a predefined pattern.

A way to further improve the solution is to apply the filtering at the level of query fields.

Typically, the solution is applied in a presentation tier (with the request that is then passed to one or more business components for its actual execution).

A specific implementation is based on hypertext pages (i.e., web pages).

In a preferred embodiment of the invention, the proposed solution is applied to a J2EE application.

A further aspect of the present invention proposes a computer program for performing the above-described method.

Moreover, another aspect of the present invention proposes a corresponding system.

The characterizing features of the present invention are set forth in the appended claims. The invention itself, however, as well as further features and the advantages thereof will be best understood by reference to the following detailed description, given purely by way of a nonrestrictive indication, to be read in conjunction with the accompanying drawings.

### BRIEF DESCRIPTION OF THE DRAWINGS

FIG. 1a is a schematic block diagram of a data processing system in which the solution according to an embodiment of the invention is applicable;

FIG. 1b shows the functional blocks of an exemplary computer of the system;

FIG. 2 depicts the main software components that can be used for implementing the solution according to an embodiment of the invention; and

FIGS. 3a-3c show a diagram describing the flow of activities relating to an implementation of the solution according to an embodiment of the invention.

### DETAILED DESCRIPTION

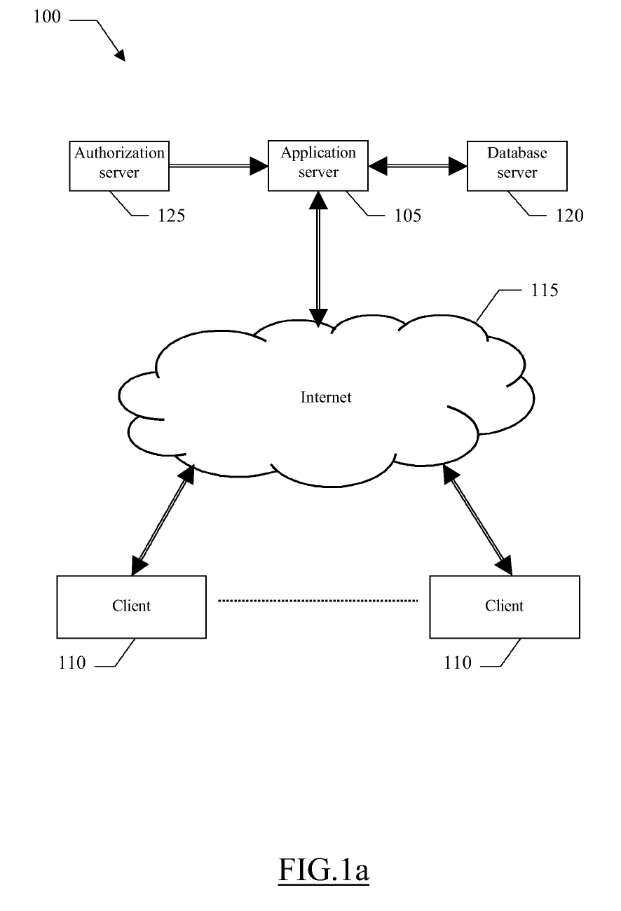

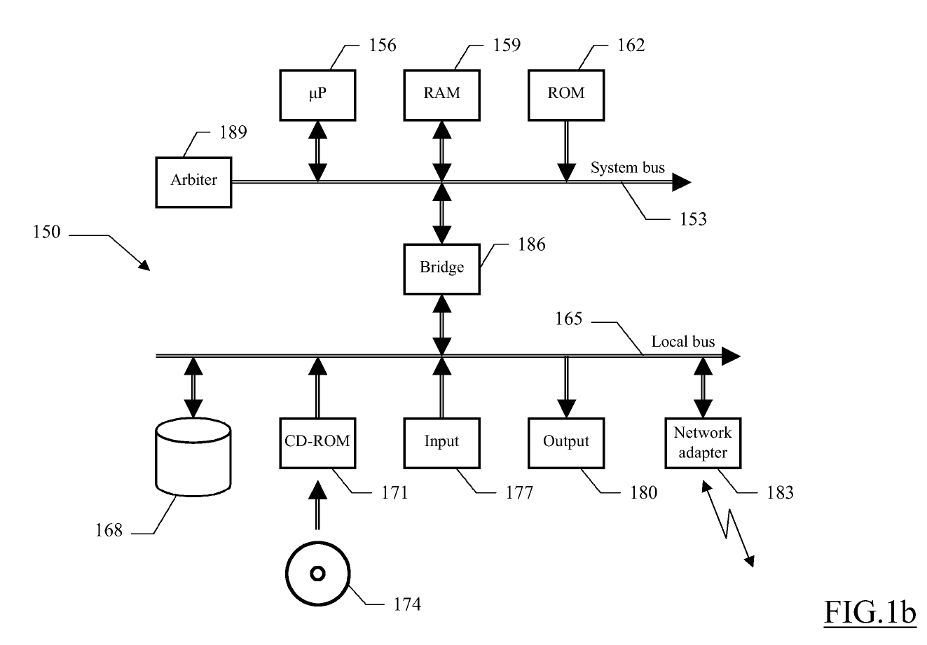

With reference in particular to the FIG. 1a, a data processing system 100 with distributed architecture is shown. The system 100 has a client/server structure, wherein application servers 105 (only one shown in the figure) run software applications for use by multiple clients 110. For this purpose, the clients 110 communicate with the application server 105 through a network 115 (typically, Internet based). The application server 105 usually stores information on a database server 120, which provides corresponding data management services to the application server 105. In addition, the application server 105 interfaces with an authorization server 125; the authorization server 125 controls any access to protected resources managed by the application server 105 (in the example at issue, the information stored on the database server 120).

Considering now FIG. 1b, a generic computer of the system (application server, client, database server or authorization server) is denoted with 150. The computer 150 is formed by several units that are connected in parallel to a system bus 153. In detail, one or more microprocessors (μP) 156 control operation of the computer 150; a RAM 159 is directly used as a working memory by the microprocessors 156, and a ROM 162 stores basic code for a bootstrap of the computer 150. Several peripheral units are clustered around a local bus 165 (by means of respective interfaces). Particularly, a mass memory consists of one or more hard-disks 168 and drives 171 for reading CD-ROMs 174. Moreover, the computer 150 includes input units 177 (for example, a keyboard and a mouse), and output units 180 (for example, a monitor and a printer). An adapter 183 is used to plug the computer 150 into the system. A bridge unit 186 interfaces the system bus 153 with the local bus 165. Each microprocessor 156 and the bridge unit 186 can operate as master agents requesting an access to the system bus 153 for transmitting information. An arbiter 189 manages the granting of the access with mutual exclusion to the system bus 153.

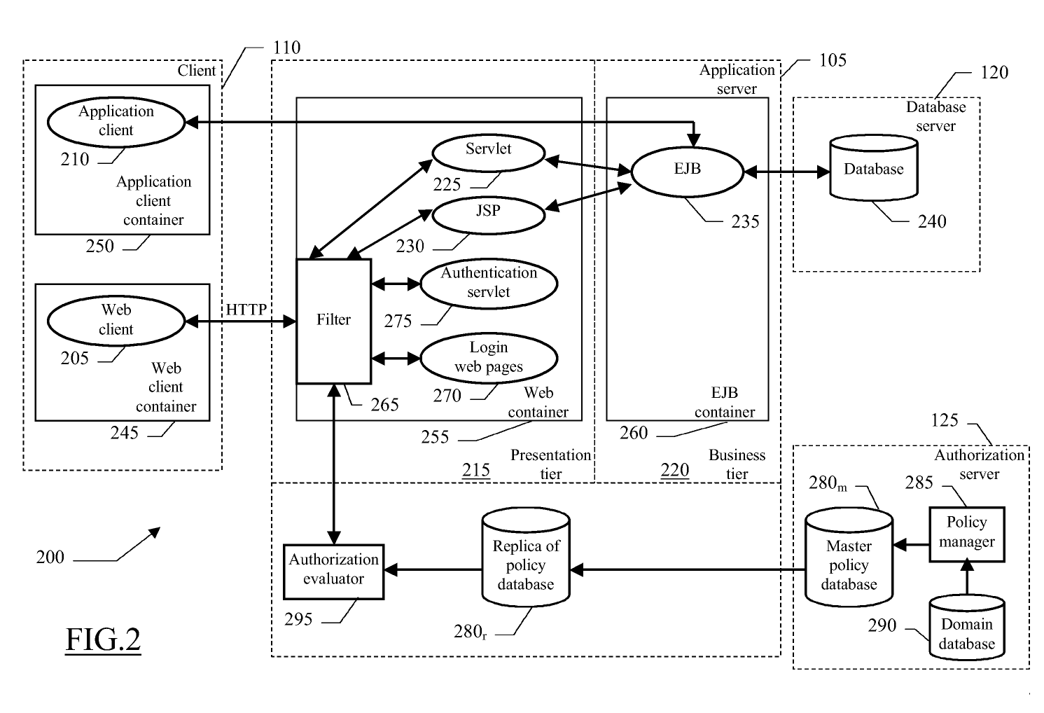

Moving to FIG. 2, the main software components that run on the above-described system define a web application that is denoted with the reference 200. The information (programs and data) is typically stored on the hard-disk and loaded (at least partially) into the working memory of each computer when the programs are running, together with an operating system and other application programs (not shown in the figure). The programs are initially installed onto the hard-disks, for example, from CD-ROMs.

Preferably, the web application 200 has a multi-tier architecture based on the J2EE technology. The J2EE technology defines a model for creating a variety of applications using components, which exploit services provided by common containers. This allows simplifying the definition of the code of the application (since a developer can now concentrate on the relevant business problems disregarding its side aspects).

More specifically, a component consists of a self-contained software module performing a specific function. Each client 110 (only one shown in the figure) can run corresponding components that consist of either web clients 205 or application clients 210. A web client 205 is used to interact with the application server 105 through web pages. The web pages are hypertext documents (formatted in the HTML language), which are managed by a system of servers in the Internet (known as the World Wide Web, or simply the web); the web uses the HTTP protocol, which defines how messages are formatted and transmitted, and what actions the clients and the servers should take in response to various commands. The web pages can include applets, which consist of small programs (written in the Java language) intended to run on clients. The web client 205 can be either of the fat type (when it performs bulk operations) or of the thin type (when it has little or not logic). On the other hand, an application client 210 is used to interact with the application server 105 through a richer set of commands, typically implemented by means of a dedicated Graphical User Interface (GUI).

Considering now the application server 105, it includes a presentation tier 215 and a business tier 220. The presentation tier 215 can run corresponding components that consist of either Java servlets 225 or JavaServer Pages (JSPs) 230. A servlet 225 is a small program written in the Java language, which is intended to run on servers to answer client requests; the servlet 225 is persistent (i.e., it maintains its state) and can satisfy multiple requests through corresponding threads that run in a single process. On the other hand, a JSP 230 is a web page that is capable of generating servlets automatically. The business tier 220 instead runs corresponding components that consist of Enterprise JavaBeans (EJBs) 235. An EJB 235 is a Java object that complies with preset specifications; the EJB 235 is used to perform specific operations in the relevant business domain of the web application 200 (such as bank, insurance, or retail organizations). Typically, the EJBs 235 manage transient sessions with the users of the clients 110, process persistent data, or implement message-based communications. For this purpose, the EJBs 235 can access one or more databases 240 of the corresponding server 120. The EJBs 235 receive requests from the web clients 205 through the presentation components 225, 230 or from the application clients 210 directly.

On the other hand, a container consists of the interface between components of a corresponding type and the underlying environment. In other words, the container provides the low-level functionality (specific for each software platform) that supports its components. Typical examples of this functionality include message exchange, scheduling, pooling, error handling, and the like; particularly, the container is responsible for forwarding requests and corresponding responses correctly (according to a corresponding mapping of the relevant components).

Considering in particular the client 110, a web client container 245 manages the execution of the web clients 205; typically, the web client container 245 consists of a web browser, which is used to retrieve, display and interact with the web pages and which includes a Java Virtual Machine (JVM) for running the applets. Likewise, an application client container 250 manages the execution of the application clients 210; typically, the application client container 250 consists of a Java Runtime Environment (JRE) . Moving to the application server 105, a web container 255 manages the execution of the servlets 225 and of the JSPs 230; examples of web containers 255 are the “WebSphere” by IBM Corporation, the “Tomcat” under the “Apache Software License”, or the Open Source “JBoss”. Likewise, an EJB container 260 manages the execution of the EJBs 235.

The web application 200 is typically packaged into a specific archive for its deployment. Particularly, the client components 205-210, the web components 225-230 and the business components 235 are archived in respective files. Each one of these files includes the relevant components together with corresponding deployment descriptors; a deployment descriptor consists of a file in the XML format containing information about the configuration of the respective component. The three files are in turn bundled into a so-called Enterprise Archive, which contains a general deployment descriptor for the whole application 200.

In the web application 200, any component is associated with a name; the mapping of the names with the actual component (in the distributed architecture of the web application 200) is managed by a dedicated naming service, such as based on the “Remote Method Invocation” (RMI) technique. For this purpose, each presentation/business (or server) component 225-235 advertises its availability with a logical name. Whenever a client component 205-210 needs to invoke a server component 225-235, it requests the naming service to translate its name into the corresponding physical location; once the client component 205-210 has obtained the reference to the server component 225-235, it can send any desired requests thereto. These operations are performed through the Java Naming Directory Interface (or JNDI), which exposes a set of standard APIs shielding the actual implementation of the naming service.

In an embodiment of the present invention, the web container 255 further includes a servlet filter 265. The filter 265 consists of a Java object that implements a specific interface. The interface exposes a series of methods that are used to intercept requests to and responses from the presentation components 225, 230; in this way, the filter 265 can use and/or transform the information that is contained in the intercepted request/response according to its programmed behavior. For this purpose, the filter 265 is defined in the deployment descriptor of the presentation components 225, 230; the specification of the filter 265 also includes a corresponding mapping, which specifies the pattern (of the requests received from the web clients 205 in the example at issue) to be filtered.

The filter 265 interfaces with a set of specific web pages 270, which are used to implement a login procedure by the user of the client 110. For example, the login web pages 270 require the entering of a username and a corresponding password, allows the user to change its password, and the like. The filter 265 then invokes a specific servlet 275, which authenticates the user (by validating its identity defined by the username according to the corresponding password).

The filter 265 is configured to communicate with an authorization service that is deployed by the authorization server 125 (for example, implemented by the above-mentioned “Access Manager”). The authorization service decides whether each request to access one or more selected resources is authorized or not, according to a predefined security policy (for a corresponding domain defined by a set of related resources). This service may be invoked by any resource manager in charge of enforcing the application of the security policy in its domain; accordingly, the resource manager prevents the access to the selected resources or implements the desired operations when the authorization is denied or granted, respectively.

More specifically, a main version of the security policy is stored into a corresponding database 280m on the authorization server 125 for each domain. The security policy identifies the resources to be protected (for example, files, web pages, databases, and the like). For each resource, the security policy then defines the users that are authorized to access the resource and the type of operations that each one of them can perform. The definition of the security policy can be based on access control lists (defining conditions necessary for a single user or a group of users to perform certain operations on each resource), protected object policies (defining conditions applying to each resource independently of the users), or authorization rules (defining conditions based on the dynamic context of the request); typically, those definitions have a hierarchical structure supporting security policy inheritance (so as to simplify their specification).

A policy manager 285 (on the authorization server 125) maintains the main security policy database 280m. The policy manager 285 also owns a database 290 storing the definition of the managed domains; particularly, the domain database 290 includes location information about all the resource managers of the different domains. The policy manager 285 replicates the main security database 280m throughout the domains, and maintains these replicas up-to-date (whenever a change is made to the main security policy database 280m).

In this specific case, a replica 280r of the security policy database is stored on the application server 105. An authorization evaluator 295 accesses the replica of the security policy database 280r, in order to determine the ability to access the desired resources. For this purpose, the authorization evaluator 295 exposes a set of APIs, which may be used to invoke the above-mentioned decision-making process by any resource manager. The authorization APIs allow any resource manager to call the centrally-managed authorization service; moreover, they provide a standard programming model that shields the complexities of the actual decision-making process to the resource manager.

In the example at issue, the resource manager consists of the filter 265. For this purpose, the filter 265 passes the credential of each user acquired during his/her authentication (for example, describing the user himself/herself, any group association, and other security-related attributes); the filter 265 also passes an indication of the resources to be accessed and of the operations to be performed (as extracted from the intercepted request). The authorization evaluator 295 uses the security policy (in the database 280r) to determine whether the request should be allowed; the authorization evaluator 295 then returns a corresponding recommendation to the filter 265.

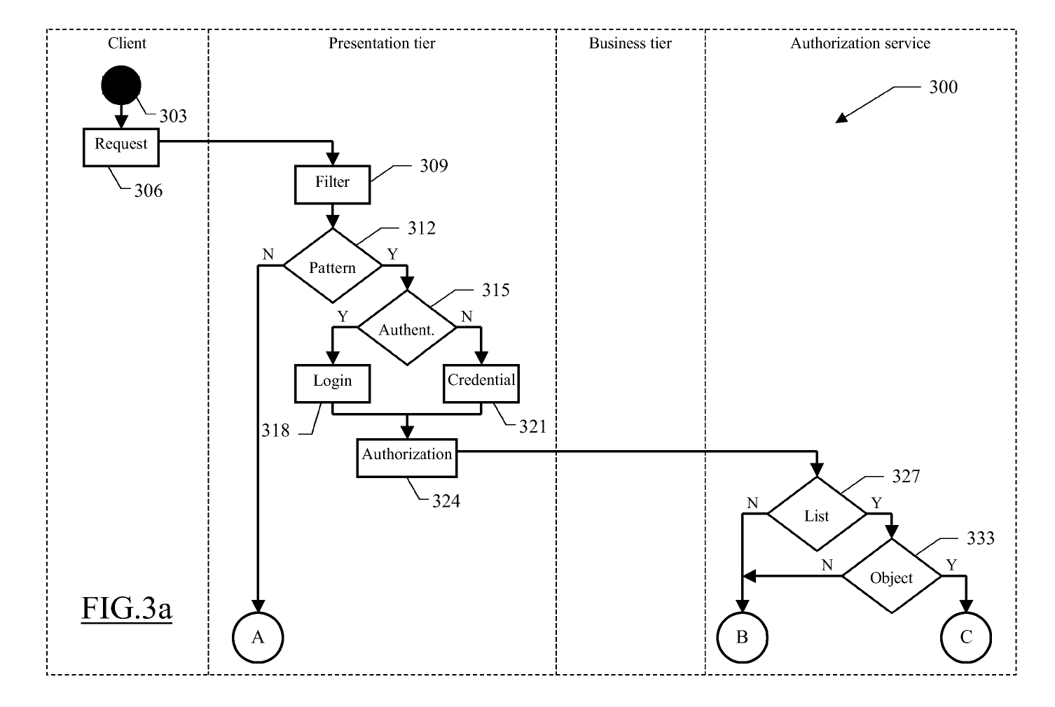

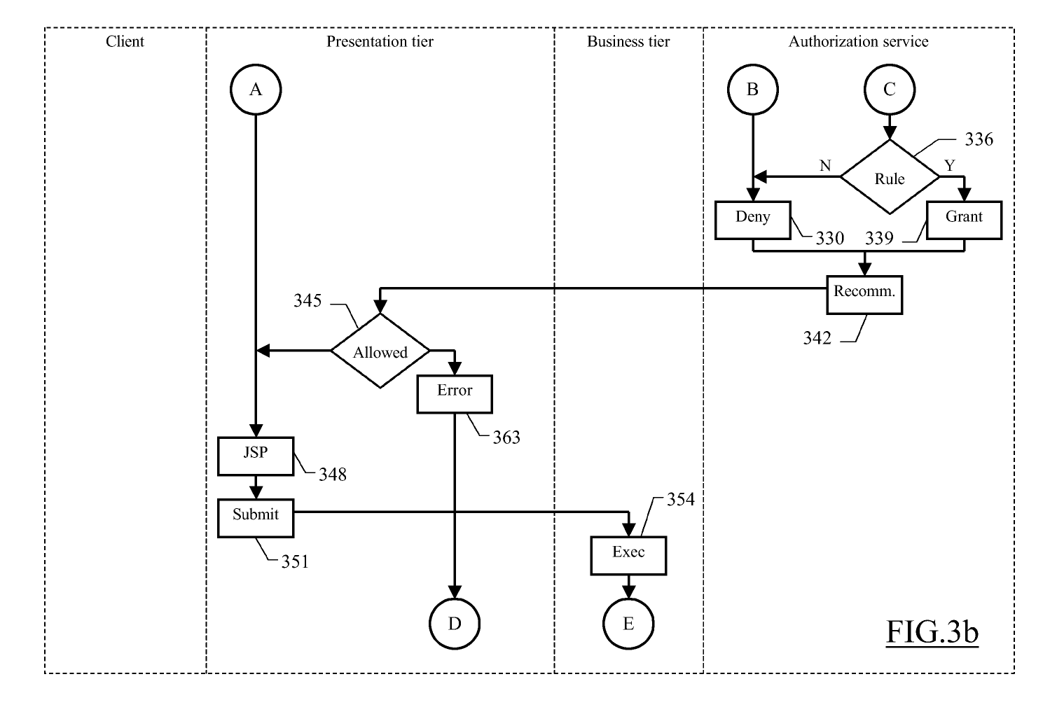

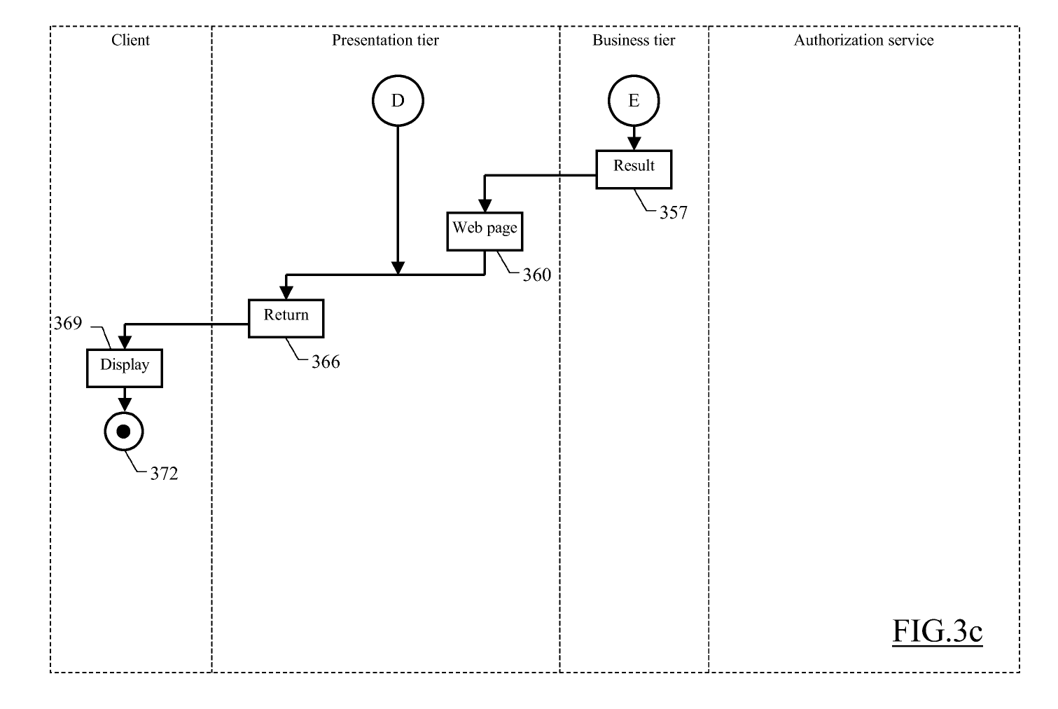

Moving now to FIGS. 3a-3c, the logic flow of an exemplary process that can be implemented in the above-described system (for accessing selected resources) is represented with a method 300. The method 300 begins at the black start circle 303 in the swim-lane of a generic client. Continuing to block 306, a corresponding web client submits a request to a desired JSP (on the application server); the process is controlled by the web client container (on the client) and by the web container (on the application server).

The request is intercepted by the filter of the web container at block 309 (in the swim-lane of the presentation tier of the application server). A test is then made at block 312 to determine whether the request matches the filtering pattern. For example, the filter may be configured to check requests including specific HTTP commands. The granularity of the filter may be extended to selected fields in the desired commands; a typical example is the specification of query strings (for extracting the value of specific fields from a database). When the request matches the filtering pattern, the flow of activity continues to block 315. In this phase, the filter verifies whether the user of the client must be authenticated (for example, because it is the first time he/she accesses the web application). If so, the user at block 318 is prompted to enter his/her username and password; assuming that the authentication process succeeds, the credential of the user is saved into a cache structure of the application server. Conversely (for example, because the same user has already been authenticated), the corresponding credential is extracted from the cache structure directly at block 321. The choice of caching the credential of the user allows improving the performance of the web application.

In both cases, the filter at block 324 requests the authorization service to verifies whether the request of the user should be allowed; for this purpose, the filter invokes the corresponding API by passing the credential of the user and the relevant information extracted from the submitted request (i.e., the selected resources and the desired operations).

In response thereto, a check is made at block 327 on the access control lists of the security policy. If the user is not allowed to perform the required operation on the selected resources (i.e., he/she is not defined in the lists associated with all the selected resources), the authorization is denied at block 330. Conversely, a further check is made at block 333 on the protected object policies. If the request is in contrast with at least one condition defined for the selected resources in the security policy (for example, because an operation incompatible with the constraints of the resources has been requested), the authorization is likewise denied at block 330. On the contrary, a still further check is made at block 336 on the authorization rules. If the dynamic context of the request does not meet its predefined characteristics (for example, because the time of the day or the day of the week is not within an allowed range), the authorization is again denied at block 330. When all the three tests described above (blocks 327, 333 and 336) are successful, the authorization is granted at block 339. In any case, the corresponding recommendation (deny or grant) is returned to the filter at block 342 (reached from the blocks 330 or 339).

The flow of activity then branches at block 345 accordingly. Particularly, if the authorization has been granted the request is passed to the desired JSP at block 348; the same point is also reached from block 312 directly when the request does not match the filtering pattern (in other words, no authorization is required). In this way, the control of the access can be implemented at the level of the presentation tier (without any impact on the business tier of the web application) . Continuing to block 351, the JSP submits the request to the corresponding EJB(s). Moving to the swim-lane of the business tier, the desired operation is executed at block 354. The result of the operation is then returned to the JSP at block 357. Continuing to block 360 (in the swim-lane of the presentation tier), this result is formatted and inserted into a corresponding web page. Referring back to block 345, if the authorization has been denied a predefined web page with an error message is retrieved at block 363.

In any case, the method joints at block 366 (from the blocks 360 or 363), wherein the web page so obtained (with the result of the request or with the error message) is returned to the client component. Moving back to the swim-lane of the client, this web page is displayed at block 369. The method then ends at the concentric white/black stop circles 372.

The above-described solution allows protecting the web application inside itself. Particularly, it is not necessary to use an additional proxy any longer; moreover, the web application is not forced to use any specific subset of the servers.

The most important feature of this solution is that it does not require any modification to the code of the components. Therefore, its implementation is completely opaque to the web application. Moreover, the same solution may also be applied to any pre-existing web application. All of the above has a beneficial impact on the security level of the system.

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

Particularly, similar considerations apply if the system has a different architecture or includes equivalent units; for example, the application server, the database server and/or the authorization server may be combined into a single computer. Moreover, each computer may have another structure or may include similar elements (such as cache memories temporarily storing the programs or parts thereof to reduce the accesses to the mass memory during execution); in any case, it is possible to replace the computer with any code execution entity (such as a PDA, a mobile phone, and the like).

It should be readily apparent that the concepts of the present invention find application in connection with any resource (either hardware or software) of the system; moreover, those concepts may be applied to control whatever kind of access (for writing, reading, deleting, moving, and the like).

Even though in the preceding description reference has been made to a specific filtering technology, this is not to be intended as a limitation; alternatively, the same solution may be implemented with any other filter of the corresponding container adapted to intercept the requests of the clients.

It is emphasized that the “Access Manager” may be replaced with any other service that is able to offer a similar set of APIs.

In any case, other solutions for authenticating the users are contemplated; for example, it is possible to use an authentication framework of the authorization server directly, a global login for web applications with their own authentication mechanism, or a single login for a community-level authentication.

The technical idea of the invention finds equal application with any other filtering pattern (for example, simply based on the resources to be accessed without the possibility of specifying a finer level of detail); in any case, a simplified implementation wherein all the requests are passed to the authentication service is not excluded.

Moreover, the solution according to the present invention leads itself to be put into practice in the EJB container as well; this feature would allow controlling the access to the protected resources even by the application clients (in addition or in alternative to the web clients).

It is pointed out that the reference to the J2EE technology must not be interpreted in a limitative manner (with the concepts of the invention that find application in any equivalent distributed application based on the concepts of software components and containers).

Similar considerations apply if the program (which may be used to implement the invention) is structured in a different way, or if additional modules or functions are provided; likewise, the memory structures may be of other types, or may be replaced with equivalent entities (not necessarily consisting of physical storage media). Moreover, the proposed solution lends itself to be implemented with an equivalent method (for example, with similar or additional steps). In any case, the program may take any form suitable to be used by or in connection with any data processing system, such as external or resident software, firmware, or microcode (either in object code or in source code). Moreover, the program may be provided on any computer-usable medium; the medium can be any element suitable to contain, store, communicate, propagate, or transfer the program. Examples of such medium are fixed disks (where the program can be pre-loaded), removable disks, tapes, cards, wires, fibers, wireless connections, networks, broadcast waves, and the like; for example, the medium may be of the electronic, magnetic, optical, electromagnetic, infrared, or semiconductor type.

In any case, the solution according to the present invention lends itself to be carried out with a hardware structure (for example, integrated in a chip of semiconductor material), or with a combination of software and hardware.

1. A method for controlling access to resources of a data processing system, the method including the steps under the control of a server entity of:
receiving a request for accessing at least one selected resource from a client entity, the request being addressed to a software component running in a software container adapted to interface the component with a software platform of the server entity,
intercepting the request by a filter of the container,
requesting an authorization to access the at least one selected resource of the intercepted request to an authorization service, and
returning an error message to the client entity in response to a denial of the authorization, or passing the request to the component in response to a grant of the authorization.

2. The method according to claim 1, further including the step of:
authenticating a user of the client in response to the interception of the request, the authorization being requested by passing an indication of the user and of the at least one selected resource extracted from the request.

3. The method according to claim 2, wherein the step of authenticating is performed by an authentication component running in the container.

4. The method according to claim 1, wherein the step of intercepting includes:
comparing the request with a predefined filtering pattern, and
requesting the authorization or passing the request to the component directly according to said comparison.

5. The method according to claim 4, wherein the request includes an indication of a query to be executed on a memory structure including a plurality of fields, the filtering pattern including an indication of protected fields of the memory structure.

6. The method according to claim 1, wherein the component is a presentation component for implementing a user interface and the container is a corresponding presentation container, the method further including the step of:
the presentation component passing an indication of the request to at least one business component (for implementing the access to the at least one selected resource, each business component running in a business container adapted to interface the business component with the software platform of the server entity.

7. The method according to claim 6, wherein the presentation component is a hypertext page.

8. The method according to claim 1, wherein each component and each container are J2EE objects.

9. A computer program product in a computer readable medium, product executed for controlling access to resources of a data processing system, under the control of a server entity comprising:
instructions for receiving a request for accessing at least one selected resource from a client entity, the request being addressed to a software component running in a software container adapted to interface the component with a software platform of the server entity,
instructions for intercepting the request by a filter of the container,
instructions for requesting an authorization to access the at least one selected resource of the intercepted request to an authorization service, and
instructions for returning an error message to the client entity in response to a denial of the authorization, or passing the request to the component in response to a grant of the authorization.

10. A system for controlling access to resources of a data processing system comprising:
means for receiving a request for accessing at least one selected resource from a client entity, the request being addressed to a software component running in a software container adapted to interface the component with a software platform of the server entity,
means for intercepting the request by a filter of the container,
means for requesting an authorization to access the at least one selected resource of the intercepted request to an authorization service, and
means for returning an error message to the client entity in response to a denial of the authorization, or passing the request to the component in response to a grant of the authorization.
